(19) United States
(12) Patent Application Publication
(10) Pub. No.: US 2018/0164766 A1
(43) Pub. Date: Jun. 14, 2018

(54) METHOD FOR DATA COLLECTION FOR THE CONFIGURATION OF A BUILDING AUTOMATION SYSTEM AND METHOD FOR CONFIGURING A BUILDING AUTOMATION SYSTEM

(71) Applicant: AIZO GROUP AG, Schlieren (CH)

(72) Inventor: Martin VESPER, Wuppertal (DE)

(21) Appl. No.: 15/508,555

(22) PCT Filed: Sep. 4, 2014
(86) PCT No.: PCT/EP2014/068847

§ 371 Date: Mar. 3, 2017

(51) Int. Cl. G05B 19/042

(52) U.S. Cl. CPC G05B 19/0426; G05B 2219/2642; G05B 2219/25168

(57) ABSTRACT

A method for data collection for the configuration of a building automation system, comprising: a) identifying a control mechanism (5, 6) and transmitting the identification data to an external data memory (11), b) providing information about the control mechanism (5, 6) identified in step a) in the external data memory (11), c) physically installing the control mechanism (5, 6) in the room designated in step b), d) repeating steps a) to c) with all of the control mechanism (5, 6) to be integrated in the building automation system, and also comprising: e) switching the building automation system on, f) connecting the building automation system to the external data memory (11), g) bringing together information that is or can be determined by the network connections between the individual components and the information from the external data memory (11).

The present invention relates to a method for data collection for the configuration of a building automation system, and to a method for configuring a building automation system.

Various building automation systems are known from the prior art. Such systems are in particular employed for the intelligent control of a building or house installation. It is, for example, possible in this way to arrange that the room is automatically darkened, the blinds closed and a background lighting switched on when the television is switched on. Similarly it is conceivable that with such building automation systems the room temperature is for example raised, the sunshades closed or the skylight closed depending on signals from sensors. Various intelligent building automation systems are similarly on the market nowadays, which permit the switching or setting of so-called scenes. It is, for example, conceivable for a romantic “candlelight dinner” lighting mood to be set in a living room at the press of a button, or that, with a further press of the button, the lighting is returned to full power so that work is easily possible at the living room table.

Common to all these building automation systems is that, in addition to the actual installation of the devices and buttons or remote controllers required for the control, a time-consuming definition of room units and scenes is also necessary. Such room units or scenes now define a group of electrical loads with their respective switching states. A switching state here does not just refer to a simple “switched on” or “switched off”, but, for example, in the case of a stereo installation, also the appropriate volume or, in the case of a light source, the corresponding dimming or lighting power. This definition of the room units or scenes is relatively complex for the ordinary user, and in any event is always time-consuming. Due to the large number of possibilities offered nowadays by typical building automation systems, it is difficult to retain an overview.

It is an object of the invention to overcome the disadvantages of the prior art; in particular a method for data collection for the configuration of a building automation system and a method for configuring a building automation system that are easy to carry out are to be made available. This object is achieved through the method defined in the independent claims.

Further forms of embodiment emerge from the subsidiary claims.

A building automation system here comprises the following components:
a network, in particular a building electrical power network with at least one electrical load and at least one signal transducer to effectuate changes in the state of the electrical load,
control means for connecting the electrical loads to the network,
control means for connecting the signal transducers to the network.

A network here refers to any apparatus that is suitable for transmitting data or signals from a first component to a second component in the network. A conventional, wired data network, based, for example, on Ethernet connections, or however also a radio-based network, in particular WLAN, can, for example, be understood as a network in the present sense.

The building automation system according to the invention is based on a network that is preferably already present in the associated building, or that is, however, installed with the individual components. In addition to the data network referred to above, the building automation system can also be based on the building electrical power network or on a combination of a data network and a building electrical power network.

A building electrical power network refers here and below to an electrical network which in particular ensures the supply of electrical power to the various electrical loads used in a building. This does not exclude the possibility that energy producers are present in the building electrical power network in addition to electrical loads, for example, alternative energy sources such as, for example, solar, wind, temporary stores etc. The building electrical power network can be connected to the public electrical power network which is usually made available in the form of an alternating voltage by a local or regional electrical power provider. An autonomous installation with alternative energy sources is, however, similarly conceivable.

In the case of a building electrical power network, the network voltage is distributed in the distributor to individual load circuits, which are usually assigned to one room or to a plurality of rooms. Each load circuit is usually secured by a circuit breaker, so that a fault in an individual load circuit does not impair the supply of energy to the whole apartment or building. At least one electrical load is arranged or at least provided in such a load circuit. Signal transducers in the form of buttons or switches that can control the state of an assigned electrical load are moreover provided in such a load circuit.

In the case of a building electrical power network, load controllers can be present in the load circuits; said load controllers can obtain information from the associated load circuit, for example from an electrical load or from a control means, and transmit it to a further electrical load, a control means, or even to a load controller of a neighboring load circuit. The load controllers are connected to one another for this purpose, for example over a bus system. A load controller can, moreover, forward information that is made available by an electrical load or a control means, to a further system for analysis.

A control means is an element that controls both a connected electrical load, and, respectively supplies specific information to the connected electrical load. In the case of a building electrical power network, the control means can make a particular voltage from the load circuit available to the electrical load. It is equally conceivable that the control means can inject information from a connected electrical load and/or a connected signal transducer or button into the network, in particular into the load circuit. A control means can correspondingly also convey information to an electrical load.

A method according to the invention for data collection for the configuration of a building automation system comprises the steps:
a. identifying a first control means of the building automation systems and transmitting the identification data to an external data memory,
b. providing information about the control means identified in step a. to the external data memory, wherein the information comprises at least a designation of the room in which the control means is to be installed, and in particular a name of the control means,
c. physically installing the control means in the network in the room designated in step b.,
d. repeating steps a. to c. with all control means to be integrated into the building automation system,
e. switching on the network,
f. connecting the building automation system to the external data memory,
g. bringing together information that is or can be determined by means of the network connections between the individual components and the information from the external data memory.

The control means is provided with a unique code, for example in the form of a one-dimensional or two-dimensional barcode, for identification. Such a unique code can be assigned to the control means at the production stage. An installer can now, for example, read in this code with an appropriate device and convey it to the external data memory.

As soon as the control means has been identified, additional information regarding the control means can be made available in the external data memory. This data can already be present in the external memory, or can be conveyed to the external data memory. For example, information regarding the room in which the control means is installed, information regarding an electrical load connected or to be connected to the control means etc. can be provided and conveyed by the installer.

It, is, of course, also possible for other devices or components to be identified, data relating to these devices or components to be made available in the external data memory, and to be installed in the network. It is thus, for example, conceivable in the case of a network that is set up on the building electrical power network, that the load circuits are provided with a load controller. A load controller can, for example, make information available relating to the circuit breaker being used in its load circuit. Information relating to applications to be made available later can similarly be provided to the building automation system or to the individual components.

It is, of course, also conceivable, that steps a. and b. are carried out for a plurality of control means of one room, and for these only to be physically installed afterwards. Thus, for example, an installer can place the components provided for a particular room ready on a working table, identify them one after another, and provide the corresponding information. The installation must then however, be carried out in accordance with the information that has been identified and provided. Such a procedure is in particular efficient if the electrical planner has already provided the information in the external data memory, and the installer, with the identification of the control means, now merely assigns the control means to the corresponding, previously-stored data. This procedure can also be carried out for an entire apartment or building with a plurality of rooms.

After the installation of the individual components of the building automation system has been done, the installer switches the network on. Switching the network on here refers to the fact that the network is established, so that data transmission is possible. In the case of a building electrical power network that is serving as the network, switching on refers to a connection to the network voltage of the network operator. A main switch is usually actuated for this purpose, or a main circuit breaker switched on. A connection to the external data memory is established, so that the data previously conveyed to the external data memory can be called up by the building automation system. The connection to the external data memory can here be created by the installer, or can be established automatically by the building automation system itself by means of an appropriate network adapter. Such a connection to the external data memory can take place over the Internet. It goes without saying that an appropriately secured connection can be established for this purpose. A connection is not only possible to the external data memory, but can also be formed between the building automation system and external devices, for example with a computer or with a mobile device.

In addition to data from the external memory, information regarding the network connections between the individual components is also determined. Such information will be referred to below as “connection” information. Thus, for example, which control means is connected to which load circuit, and thereby with which load controller, is detected. A determination is similarly made of which control means are connected to one another. The network adapter can also be identified, and corresponding data can be stored in the external data memory.

A further aspect of the present invention relates to a method for configuring a building automation system. The building automation system here comprises the same components that were already described above for data collection. The method comprises the following steps:
collecting the data from a combination of the information that is or can be determined by means of the network connections between the individual components and the information from the external data memory, in particular as outlined above,
evaluating the information according to a predetermined or predeterminable algorithm, wherein the evaluation is, in particular, performed automatically,
storing the evaluated information in the building automation system.

Such an algorithm can already be integrated into the components of the building automation system, or can, however, be stored in the external data memory and called up from there, or can even be present in an additional device. The algorithm then determines which information is combined, and which configurations are set in the building automation system. The algorithm can here be started manually, for example by the installer, or automatically.

The algorithm can take into account specified configuration rules and, in particular, also information from previously installed building automation systems, such as for example standard designations or standard behavior, data from statistical evaluations, or data from general understanding. The building automation system thus becomes increasingly easy to configure, since empirical values of already existing systems can also be taken into account. Production data relating to the individual components can also be made available and can give helpful advice on fault rectification, for example in the event of a malfunction. General understanding refers here to the fact that, for example, a switch described as a light switch cannot be used for the control of the fire alarm, or that, apart from the processes of switching on and off, the speed of a roller blind motor cannot be controlled.

The corresponding, number of rooms can be conveyed to the building automation system on the basis of the room designation of the individual control means and of the connection between the control means. Furthermore, in the case of a building automation system that is based on the building electrical power network, an assignment of the load controllers to the corresponding rooms, and in particular of the individual rooms to the corresponding load circuits, can be made from the connections between control means and load controllers. This assignment, or this number of rooms with the corresponding designations, can be stored in the building automation system and/or conveyed to the external memory. Through this combination of the “connection” information with the data from the external data memory, it is possible, for example, for predefined switching scenes to be preconfigured, without the installer defining further information or links. For example, the electrical loads that are located in a room are detected in this way, so that a preset “room off” scene for example switches off the light in the corresponding room, without further adjustments by the installer or the user. Historical data from previously installed building automation systems can, furthermore also be taken into account, in order, for example, to define a switching scene or a name that is meaningful to the user. In particular it is possible to compare which components have already had which information added to them at an earlier point in time. For example, a “panic” button, which the installer has designated as “panic button”, is directly linked to the “all lamps on” function, since this configuration is already known from other building automation systems. Similarly it is, for example, conceivable that an external lamp at the entry door is immediately provided with a switch-off delay of, for example, 2 minutes. It is, of course, possible for such automatic information or basic information to be changed in a manner defined by the user, and to be configured differently.

Specific components can, of course, already be explicitly linked to the appropriate function on the basis of their identification data. A “panic button” can, for example, already have a unique design that distinguishes it from another button. The installer no longer has to make the “panic button” designation; the button only has to be identified and installed.

The algorithm can, for example, read out all the room designations in the building automation system, and can define and name the corresponding number of rooms. Basic information that is already given, for example by the number of load controllers used, can be overwritten here. Similarly, standard room designations that are used in a typical building or apartment can be used or overwritten. The individual control means are then assigned to the designated rooms. The control means also is named in accordance with the names specified by the installer or already stored in advance in the external data memory, so that it can later be identified easily during a modification to the configurations. Similarly the individual load controllers can be named, wherein the name of the load controller is composed, for example, of the room designations that correspond to the associated load circuit or to the control means present in the load circuit.

Further configurations can also be made. Thus for example, the hardware type of each component, in particular of each control means, can be called up. Standard configurations can, for example, be stored in a database for each hardware type. This standard configuration can be adopted if no configuration data for the components have been stored by the installer or previously entered in the external data memory. If, however, data is present in the external data memory, these is accordingly adopted. A plausibility check can, however, take place here, in order to rule out possible incorrect functions in advance. Different actions are required, depending on the information that is available. Thus, for example, the information regarding the maximum power or the socket of a lamp can be called up. Similarly it is conceivable that information regarding the specific lamp bulb of a dimmable lamp is called up, and, for example, the dimming curve set on the basis of the EAN/GTIN number.

Each control means can be identifiable individually and uniquely. The identification can, for example, take place with reference to the EAN/GTIN number in combination with a serial number SGTIN and/or with reference to a corresponding barcode. The more complete the identification of the control means present, the more completely can a configuration, in particular an automatic configuration, of the building automation system take place. Similarly, other devices and components that are installed in the network can also be individually and uniquely identifiable.

The control means, in particular each control means, can have a virtual image in the external data memory. Any further device or any further component in the building automation system can similarly have a virtual image. Accordingly, the data conveyed by the installer can be assigned to a database of the corresponding control means, device or component. This virtual image can comprise the information for the corresponding control means, device or component, and make it available for further use when required. The virtual image can, moreover, already be provided with selected basic information during the production of the control means, device or component. This again simplifies the work of the installer, so that the installer is not required to enter so much information during the installation. Possible basic information includes:
Product designation
Version of the hardware
Version of the software
Production date
Test results
Predefined designations
Reference to supplementary documentation such as connection plans, images, link to manufacturer's page
etc.

The information regarding the control means, devices or components can also comprise, in addition to the unique identification data, information selected from the following group:
designation of the room in which the control means is installed,
the position of the control means,
special functions of the control means,
information regarding the type of electrical load that is connected or to be connected, such as for example dimmable or switchable,
the maximum permitted power of the electrical load that is connected or to be connected,
the maximum available power that can be made available to a connected electrical load, or which can be consumed by said electrical load,
control information related to individual scenes,
the color or mode of the control means,
information regarding the installer, such as for example address and name,
installation date,
etc.

Information regarding the individual control means, devices or components themselves, on the connected devices, or related to the installation is conceivable.

A mode of the control means can, for example, refer to an assignment to its application area, wherein a corresponding color can be assigned to each application area for simpler identification. A division into the following application areas with the corresponding colors is thus, for example, possible:
Light—yellow,
Shade—grey,
Air conditioning—blue,
Audio—cyan,
Video—magenta,
Safety—red,
Access—green,
Joker—black, where the joker is freely configurable.

Other application areas and other color assignments are, of course, also conceivable.

Control means can communicate with one another or with the load controllers, in particular via the electrical power cable. Similarly however, other communication paths, such as, for example, radio or optical communication lines, are conceivable. Accordingly, the control means are connected to one another or to the load controllers, in particular via the electrical power cable. This direct connection again enables basic information, as described before as “connection” information. It is, moreover, also conceivable that the control means can communicate with one another.

In the case of a building automation system based on the building electrical power network with corresponding load controllers, the load controllers can communicate with one another and are in particular connected to one another via, in particular, a wired cable. Other communication paths are again here conceivable. In this way it is made possible for an electrical load in another load circuit to also be controlled by a control means that is connected, for example, to a button as a signal transducer. In addition, general scenes, such as for example “panic”, which for example switches all or selected lamps in the entire building automation system, are thus enabled. It is also, of course, possible to undertake actions over more than one room in other networks.

After completion of the configuration the building automation system can individually operate individual electrical loads, in particular each lamp, in order to check the function of the building automation system. At the same time, through the visual switching on of the individual lamps, the option is offered to the installer of following the checks and, if relevant, recognizing and correcting faults. The building automation system can furthermore also operate individual electrical loads individually and measure their consumption, in order, for example, to determine the operation mechanism. In the case of lamps in particular, it is in this way possible to determine whether they are dimmable by a leading edge phase cut, a trailing edge phase cut, or not at all.

After completion of the configuration the building automation system can carry out a plausibility check in order to check the individual assignments of control means to the room or load controller, or of control means to electrical loads. It is, for example, possible to detect in this way when a control means that is assigned to a lamp has been incorrectly connected to a heater.

The information regarding the control means can be provided by the installer during installation of the control means and conveyed to the data memory. Similarly it is however also conceivable that the information regarding the individual control means is provided in the external data memory prior to the physical installation, and that the installer merely assigns the control means to the corresponding virtual image. Such a procedure is, for example, conceivable when a relatively large development with identical apartments is built, and the electrical planner already provides the corresponding data.

The identification of the control means and the provision of the information can be performed by the installer by means of a mobile data acquisition device, in particular by means of a mobile telephone. For this purpose the mobile telephone can, for example, have a specific app that permits recording of the data and establishes the contact to the external data memory. It is, for example, conceivable that the installer records the information by means of speech input, and that the system analyses the spoken information and prepares it appropriately for further processing. Thus, for example, a spoken sentence: “This is a ceiling lamp in the living room. It is dimmable, and has a halogen bulb with a maximum power of 80 watts” can be analyzed, and the following information about the electrical load identified in it:
lamp,
ceiling,
living room,
dimmable,
halogen bulb,
80 watts.

It is also conceivable that other systems are used, such as for example an intelligent spectacles system with head-up display, in particular Google Glass or similar products, which permits the identification of the component to be installed and the simultaneous input of further data.

A configuration report can be prepared from the data that is brought together, and the individual components or applications of the building automation system configured in accordance with the configuration report. This configuration report can, for example, be stored in the building automation system, in particular non-centrally. It is equally conceivable that the configuration report is stored, in particular additionally, in the external data memory. A configuration report is helpful in particular when the configuration is performed automatically. Such a configuration report is, in particular, also advantageous when the basic configuration is changed and is to be set or modified in a user-specific manner. A saved configuration report can also be helpful in the event of a later restoration of the configuration.

The control means can be integrated into an electrical connection terminal. Such a connection terminal can, for example, have a form similar to that of a terminal strip. An integration into a connection terminal permits a very simple installation of the control means, since connection terminals are usual, in particular in building electrical power networks, and the installer does not have to be additionally trained. It is also conceivable that the control means is already integrated into an electrical load, so that an additional installation is superfluous. An intelligent connection terminal that is integrated into a lamp socket or into a roller blind controller is, for example, conceivable.

A data connection to a configuration unit can be established for further configuration or for modification of the base configuration or of a configuration that has already been set. Such a configuration unit here refers, for example, to a mobile telephone, a smartphone, a tablet or a notebook. Such a data connection is then normally based on a wireless connection. Similarly it is however also conceivable that the configuration unit is installed on a PC, so that preferably a wired data connection is established. With the use of such a configuration unit, the user can see the configuration protocol and/or also modify configurations of the building automation system in a user-specific manner.

The data connection to the configuration unit can, as already explained with reference to the external data memory, be made over the Internet. The entire building automation, or the control of the electrical loads of a building, can accordingly be called up and/or monitored and/or configured independently of location. It goes without saying that such a data transfer is, for good reasons, secured through appropriate safety standards such as encryption.

The invention is explained in more detail below with reference to figures. Here:

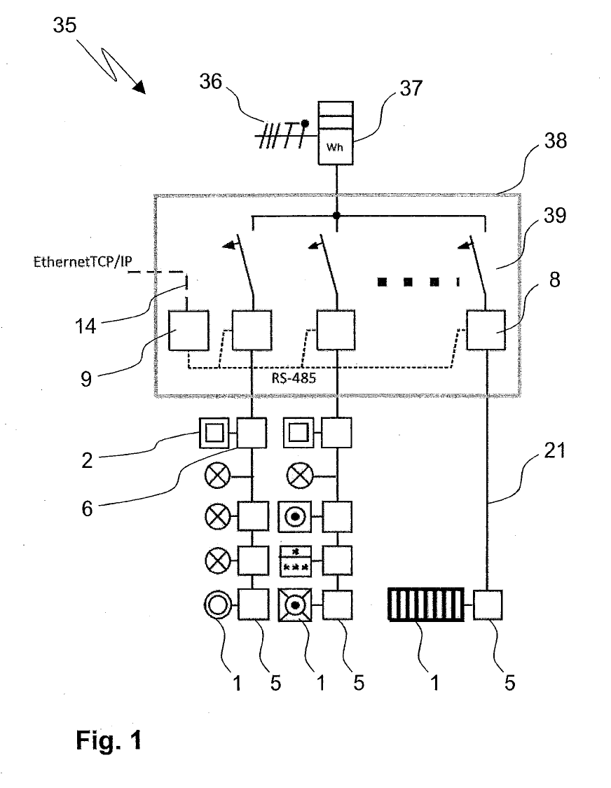

FIG. 1: shows a schematic illustration of a building electrical power network,

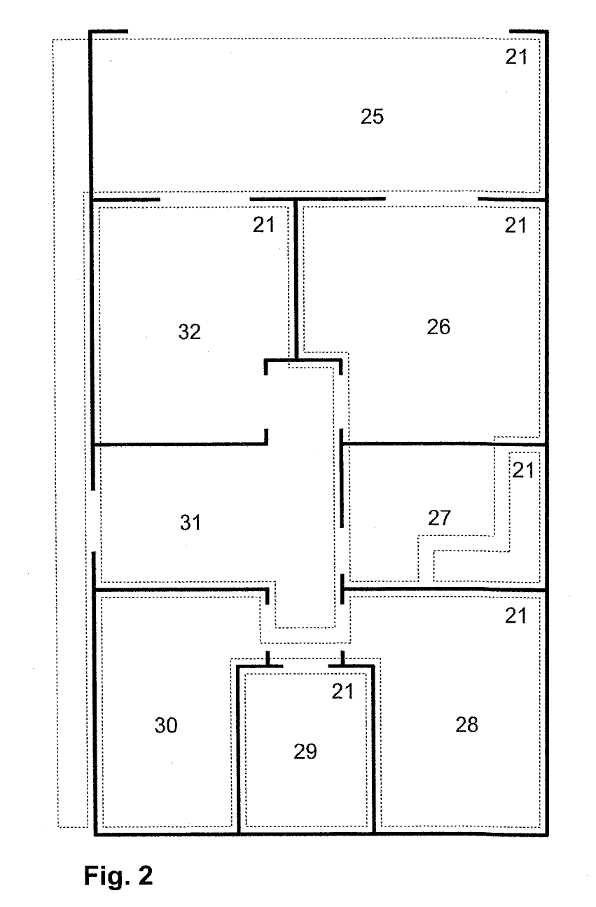

FIG. 2: shows an outline of an apartment in which the individual rooms and load circuits are illustrated,

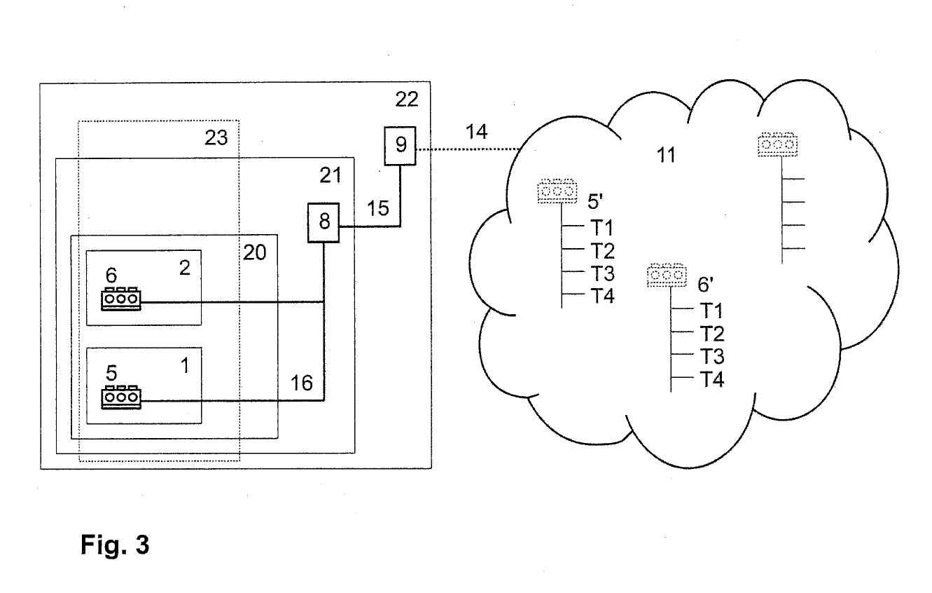

FIG. 3: shows a schematic illustration of a building automation system.

A schematic illustration of a building electrical power network 35 which serves as a network in the sense of the present invention is shown in FIG. 1. The supply of energy for the building or apartment is made through a network access 36, which is usually made available by a local or regional electrical power provider, through an electricity meter 37 to a distributor 38. In this distributor 38 the network voltage is distributed to the individual load circuits 21, wherein each load circuit 21 has its own circuit breaker 39 which permits disconnection of the load circuit 21 from the network access 36 in the event of a fault. Each load circuit 21 is furthermore provided with a load controller 8, said controllers being connected to one another via an RS-485 bus. A network adapter 9, which permits an Internet connection 14, is also connected via this RS-485 bus. This Internet connection 14 is illustrated as Ethernet TCP/IP. The network adapter 9 can, in addition to the connection to the Internet, also permit a connection to a LAN network internal to the building, to which further devices can also be connected. Devices that are not connected to the illustrated building electrical power network 35 are thus also configurable.

Electrical loads 1 are connected through control means to the load circuits 21 through the conventional electrical power cables. These control means 5 are implemented in the form of connection terminals which, however, permit additional functions for the building automation. These control means thus communicate via the electrical power cable with the load controllers and control, for example, the power that is made available to the electrical load. A control means can, for example, switch on and off and/or dim a connected lamp. Signal transducers in the form of buttons 2 which forward a switch impulse to the control means 6 in order to operate individual and/or selected electrical loads 1, via their switching means 5, in the load circuit 21 or across load circuits are also connected via a control means 6 to the load circuit 21. For example, a single button actuation can switch an electrical load 1 assigned to the button 2 on or off. A double button actuation can, for example, affect all the electrical loads in the corresponding room, depending on what configuration has been stored for a double button actuation, or on the scene which corresponds to this double button actuation. The building automation system can, of course, also function without the illustrated load controller if, for example, the connection between the individual control means 5, 6 is provided via an alternative network, in particular a WLAN network.

FIG. 2 shows an outline of an apartment in which the individual rooms and load circuits 21 are illustrated. Thus for example the entire living room 26 and the lighting, as well as the sockets in the kitchen 27, are assigned to a first load circuit, while the kitchen appliances have a separate load circuit. A further load circuit comprises the two bedrooms 28, 30; the bathroom 29 again has a separate load circuit. The hallway 31 and the lounge 32 are again assigned to a common load circuit. The load circuit of the terrace 25 extends over the front side of the apartment, and also comprises an electrical load that is arranged, for example, in front of the entry doors.

A schematic illustration of a building automation system is shown in FIG. 3. An electrical load 1 with a control means 5 in the form of a connection terminal is shown as the smallest unit. This electrical load 1 is located in a room 20 together with a signal transducer in the form of a button 2 which is connected via a control means 6 in the form of a button terminal to the data line 16. In the case of both the button terminal and of the connection terminal of the electrical load 1, the data line is the electrical power cable itself. This electrical power cable or data line 16 is connected with a load controller 8 of the load circuit 21, which, if necessary, conveys the switching pulse of the button 2 to a neighboring load circuit (see FIG. 1). The switching impulse is conveyed directly from the button 2 via the button terminal and the electrical power cable 16 to the connection terminal 5 for the control of the electrical load 1. As described above, so-called scenes 23 that are defined in the building automation system can also be called up by the button 2. Such a scene 23 can not only relate to electrical loads from the same load circuit, but can also affect electrical loads from other load circuits. The corresponding switching pulse is thus conveyed via the button terminal and the data line 16 to the load controller 8 of the first load circuit 21. Since the load controller 8, as explained above in relation to FIG. 1, is connected with the load controllers of the neighboring load circuit, the switching pulse can also be transmitted to the further electrical loads or their control means or connection terminals. If the individual control means 5, 6 are connected via an alternative network, for example a radio network, the load controllers are not essential, and they can be omitted. A switching pulse is then conveyed via the alternative network from a first control means to the control means or the connection terminal of the electrical load that is to be switched.

During the installation and initial configuration, network adapter 9 is connected via a data line 15 to the load controllers 8. It is sufficient here if a single load controller 8 is connected with the network adapter 9, since the load controllers are also connected to one another, and can mutually exchange data. The network adapter 9 will establish a connection, in particular an Internet connection 14, with an external memory 11, illustrated as a cloud. A virtual image 5′, 6′ of each control means 5, 6, which contains a large number of data T1, T2, T3, T4, is present in this external memory 11. The virtual image 5′, 6′ was already generated during the production of the control means 5, 6, and completed with further data during the installation. The installer has thus, for example, identified control means 6 as a button terminal, and has assigned information relating to the room and the position in the room, for example “bedroom 1” and “wall east next to the room door”, to it. The installer has identified the control means 5 as a connection terminal, and has also assigned a room and a position in the room, for example “bedroom 1” and “ceiling lamp” to it. In a building automation system with a network that is independent of the building electrical power network, the network adapter is integrated into the network, and then communicates via the corresponding network connections with the individual control means.

In a first configuration, the building automation system will combine the information from the virtual image 5′, 6′ with the information that is available from the connections in the corresponding network. The building automation system accordingly knows that both control means 5 and 6 are located in the same room 20, that is to say in “bedroom 1”. It is also possible to determine in which load circuit 21 the two electrical load control means 5 and 6 are located. Basic settings, such as for example switching the connected electrical loads on or off when an arbitrary button is double-actuated, can also be already configured.

1-15. (canceled)

16. A method for data collection for a configuration of a building automation system, wherein the building automation system comprises the following components:
a network with at least one electrical load and at least one signal transducer to effectuate changes in the state of the electrical load,
control means for connecting the electrical loads to the network,
control means for connecting the signal transducers to the network,
the method comprising:
a) identifying a control means and transmitting the identification data to an external data memory,
b) providing information about the control means identified in step a) to the external data memory, wherein the information comprises at least a designation of the room in which the control means is to be installed,
c) physically installing the control means in the network in the room designated in step b), and
d) repeating steps a) to c) with all control means to be integrated into the building automation system,
further comprising:
e) switching on the network,
f) connecting the building automation system to the external data memory, and
g) bringing together information that is or can be determined by the network connections between the individual components and the information from the external data memory.

17. The method according to claim 16, wherein the information further comprises a name of the control means.

18. The method according to claim 16, wherein the network is a building electrical power network.

19. The method according to claim 16, wherein in that the bringing together of the information occurs automatically when a connection to the external data memory exists.

20. A method of configuring a building automation system, the method comprising:
a step of data collection from a combination of information that is or can be determined by network connections between the individual components and the information from an external data memory,
a step of evaluating the information according to a predetermined or predeterminable algorithm, and
a step of storing the evaluated information in the building automation system.

21. The method according to claim 20, wherein the data collection is performed wherein the building automation system comprises the following components:
a network with at least one electrical load and at least one signal transducer to effectuate changes in the state of the electrical load,
control means for connecting the electrical loads to the network,
control means for connecting the signal transducers to the network,
the method comprising:
a) identifying a control means and transmitting the identification data to an external data memory,
b) providing information about the control means identified in step a) to the external data memory, wherein the information comprises at least a designation of the room in which the control means is to be installed,
c) physically installing the control means in the network in the room designated in step b), and
d) repeating steps a) to c) with all control means to be integrated into the building automation system,
further comprising:
e) switching on the network,
f) connecting the building automation system to the external data memory, and
g) bringing together information that is or can be determined by the network connections between the individual components and the information from the external data memory.

22. The method according to claim 20, wherein the evaluation is performed automatically.

23. The method according to claim 20, wherein the algorithm takes specified configuration rules into account.

24. The method according to claim 23, wherein the algorithm also takes into account information from previously installed building automation systems, such as for example standard designations or standard behavior, data from statistical evaluations, or a general understanding.

25. The method according to claim 20, wherein each control means is individually identifiable.

26. The method as claimed claim 20, wherein the control means has a virtual image in the external data memory.

27. The method as claimed claim 20, wherein each control means has a virtual image in the external data memory.

28. The method according to claim 27, wherein the virtual image comprises the information regarding the corresponding control means.

29. The method according to claim 28, wherein selected basic information of the control means is already stored in the virtual image during the production of the control means.

30. The method according to claim 20, wherein the information regarding the control means also comprises, in addition to the unique identification, information selected from the following group:
designation of room in which the control means is installed,
a position of the control means,
special functions,
information regarding a type of electrical load that is connected or to be connected,
a maximum permitted power of the electrical load that is connected or to be connected,
a maximum available power,
control information of individual scenes,
a color or a mode of the control means,
information regarding an installer, and
installation date.

31. The method according to claim 20, wherein the control means communicate with one another.

32. The method according to claim 31, wherein the control means communicate with one another over wires.

33. The method according to claim 31, wherein the control means communicate with one another over an electrical power cable.

34. The method according to claim 20, wherein after completion of the configuration the building automation system individually operates and/or measures individual electrical loads, in order to check a function of the building automation system and/or to determine the operation mechanism of the electrical load.

35. The method according to claim 34, wherein the individual electrical loads to be operated and/or measured are each individual lamp.

36. The method according to claim 20, wherein after completion of the configuration, the building automation system carries out a plausibility check in order to check individual assignments of the control means to the electrical loads.

37. The method according to claim 20, wherein the information regarding the control means is provided by an installer during installation and conveyed to the data memory.

38. The method according to claim 20, wherein the information regarding the control means is already available in the data memory before the installation, and an installer only assigns the control means to the corresponding virtual image.

39. The method according to claim 20, wherein a configuration report is prepared.

40. The method according to claim 39, wherein the configuration report is stored non-centrally in the building automation system.

41. The method according to claim 16, wherein each control means is individually identifiable.

42. The method according to claim 16, wherein the control means has a virtual image in the external data memory.

43. The method according to claim 16, wherein each control means has a virtual image in the external data memory.

44. The method according to claim 43, wherein the virtual image comprises the information regarding the corresponding control means.

45. The method according to claim 44, wherein selected basic information of the control means is already stored in the virtual image during the production of the control means.

46. The method according to claim 16, wherein the information regarding the control means also comprises, in addition to the unique identification, information selected from the following group:
designation of room in which the control means is installed,
a position of the control means,
special functions,
information regarding a type of electrical load that is connected or to be connected,
a maximum permitted power of the electrical load that is connected or to be connected,
a maximum available power,
control information of individual scenes,
a color or a mode of the control means,
information regarding an installer, and
installation date.

47. The method according to claim 16, wherein the control means communicate with one another.

48. The method according to claim 47, wherein the control means communicate with one another over wires.

49. The method according to claim 47, wherein the control means communicate with one another over an electrical power cable.

50. The method according to claim 16, wherein the information regarding the control means is provided by an installer during installation and conveyed to the data memory.

51. The method according to claim 16, wherein the information regarding the control means is already available in the data memory before the installation, and an installer only assigns the control means to the corresponding virtual image.

52. The method according to claim 16, wherein a configuration report is prepared.

53. The method according to claim 52, wherein the configuration report is stored non-centrally in the building automation system.
